(19) United States
(12) Patent Application Publication
(10) Pub. No.: US 2007/0198682 A1
(43) Pub. Date: Aug. 23, 2007

(54) Method and system for seamless media handover across devices

(76) Inventors: Rajesh S. Pazhyannur, Lake Zurich, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/359,069

(22) Filed: Feb. 22, 2006

(51) Int. Cl. G06F 15/173

(52) U.S. Cl. 709/223

(57) ABSTRACT

A method and a system for enhancing user experience by reducing the handover delay of media and more specifically for providing more seamless transfers of media experiences across devices. The method comprises steps of identifying (205) a trigger condition for the pre-handover procedure from a first device and preparing (210) a media application enabled to render the media experience in a dormant mode in a second device, if the trigger condition is met.

### FIELD OF THE INVENTION

The present invention relates generally to communication systems and more specifically to seamless media handovers across devices.

### BACKGROUND OF THE INVENTION

A person normally moves in and out of various environments, for example an office environment, a home environment, and an auto environment or could be in transit. These spaces tend to have distinct characteristics in terms of available devices (and their capabilities) and available communication networks (and their capabilities). Therefore, an end user experience may be divided between at least two of these distinct spaces. Some of these available devices can play a particular kind of media on a media application. The media can be a streaming application where a device retrieves the media from a distinctly located streaming server that stores the content. Another example is a device that plays media from a local storage such as a hard disk, or flash memory card.

In a particular situation a user is out-in-the-world and is listening to music through a streaming service, for example on his mobile device using a media player (for example an MP3 player). A home has a music system and is connected to the Internet through broadband network. When the user walks into the home, the user may want to continue listening to the music but through the music system in the home. For this purpose, the user may like to transfer the rendering of the music experience from his mobile device to the music system at home. More generally, as the user condition changes (for example, the user moves between different environments), the user may prefer to continue the media experience on different devices. At one extreme, the user may manually switch the media experience from one device to another (for example, by starting it on one device and closing it on another device). At the other extreme, the user may specify a completely automated system where the system chooses the optimal devices and switches automatically the media experience from one device to another.

In the existing scenario, systems enable transfer of media between two networks on the same device (referred to as inter-network intra-device) as well as transfer of media across devices (referred to as inter device transfers). These systems suffer from a limitation common to media applications. Such applications require a warm-up that plays a role in how long it takes to move media experience across devices. The warm-up adversely affects the end user experience by increasing the time interval to transfer the media experience from one device to another. There are multiple factors that can affect the warm-up time such as network delays in fetching the streaming server, startup delay in preparing the media application or loading up of jitter buffers.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of devices in different defined environments in accordance with various embodiments of the present invention.

FIG. 2 illustrates a flow diagram for a method of enabling a pre-handover procedure of a media experience across a plurality of devices in accordance with an embodiment of the present invention.

FIG. 3 illustrates a flow diagram elaborating the method of enabling the pre-handover procedure in accordance with an embodiment of the present invention.

FIG. 4 illustrates a flow diagram of a method to enable transfer of a media experience across a plurality of devices in accordance with an embodiment of the present invention.

FIG. 5 illustrates a flow diagram elaborating the step of providing the media experience on a device on which the media experience can be transferred in accordance with an embodiment of the present invention.

FIG. 6 illustrates a system to enable a transfer of a media experience across devices in accordance with an embodiment of the present invention.

FIG. 7 illustrates an exemplary embodiment depicting a pre-handover procedure.

FIG. 8 illustrates an exemplary embodiment depicting a handover procedure.

### DETAILED DESCRIPTION OF THE INVENTION

Before describing in detail embodiments that are in accordance with the present invention, it should be observed that the embodiments reside primarily in combinations of method steps and apparatus components related to a method and apparatus for enhancing user experience by reducing handover delay caused while transferring media experience across devices. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of the method and apparatus for enhancing user experience by reducing handover delay caused while transferring media experience across devices described herein. The non-processor circuits may include, but are not limited to, a radio receiver, a radio transmitter, signal drivers, clock circuits, power source circuits, and user input devices. As such, these functions may be interpreted as steps of a method to enhance the user experience by reducing the handover delay caused while transferring media experience across devices described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the invention deals with methods to reduce the handover delay while transferring media experience across devices. “Handover delay” can also be called “warm-up time”, and is generally known in the art. The terms “handover delay” and “warm-up time” will, thus, be used interchangeably herein. The reduction in the warm-up time leads to faster transitions of media experience between devices. The invention proposes to enhance the user experience by proving more seamless transfers of media experiences across devices. Those skilled in the art will realize that the above recognized advantages and other advantages described herein are merely exemplary and are not meant to be a complete rendering of all of the advantages of the various embodiments of the present invention.

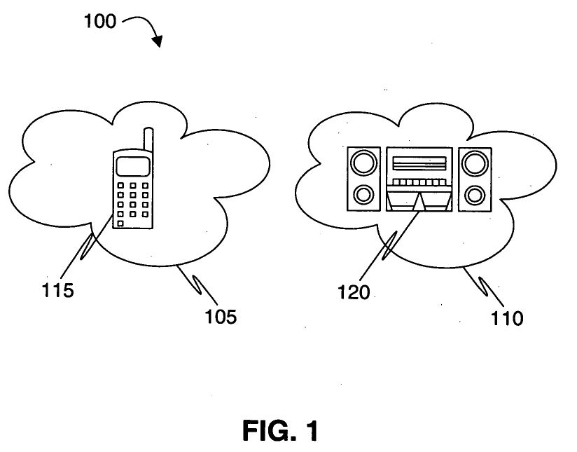

Referring now to the drawings, and in particular FIG. 1, a block diagram depicting devices in different defined environments is shown in accordance with various embodiments of the present invention and is indicated generally at 100. Those skilled in the art, however, will recognize and appreciate that the specifics of this illustrative example are not specifics of the invention itself and that the teachings set forth herein are applicable in a variety of alternative settings. For example, since the teachings described do not depend on the number or type of devices and defined environments, they can be applied to any number or any type of devices and defined environments although only one device in each of the two defined environments is shown in this embodiment. For example, a device 115 belongs to a defined environment 105 and a device 120 belongs to a defined environment 110 is depicted in FIG. 1. As such, other alternative implementations of using a plurality of devices belonging to a plurality of defined environment are contemplated and are within the scope of the various teachings described.

The defined environments 105 and 110 where the devices 115 and 120 exist respectively can comprise an office environment, a home environment, or an auto environment, or a user handling a device could be in transit or out-in-the-world environment. An office environment can provide laptops or desktops and high speed networking capability. The home environment can provide laptops or desktops with broadband (cable or DSL) networking capability. An auto environment can have some telematics systems that can provide limited form of network support using cellular and/or satellite systems. The out-in-the-world environment refers to an environment in which the user is out “in the world” (and not in the environments above). The invention proposes a method and a system, which enables seamless transfers of media experiences across devices by reducing handover delays and thereby enhancing user experience.

Referring to the embodiment depicted in FIG. 1, in a particular situation a user is out-in-the-world 105 and is listening to music through a streaming service on his mobile device 115. The user walks into a home 110. The home 110 has a music system 120 and is connected to the Internet through, say, a broadband network. Pursuant to the embodiments of the present invention the user can continue listening to the music but through the music system 120 in the home 110 with very little or no handover delay. The media experience of listening to music is transferred automatically from his mobile device 115 to the music system 120 when the mobile device 115 enters the home 110, such that the user perceived latency is avoided. This latency or warm-up occurs when the streaming content (for example music) continues to be rendered out, for example displayed or played, from a first device (for example the mobile device 115), after a second device (for example the music system 120) becomes the device for rendering the streaming content. Those skilled in the art shall realize that the warm-up time can comprise many factors such as starting of the media application and filling up the jitter buffer before playback.

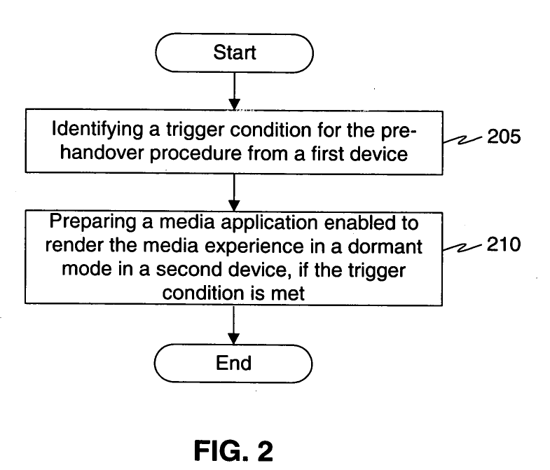

Turning now to FIG. 2, a flow diagram for a method of enabling a pre-handover procedure of a media experience across devices is shown in accordance with an embodiment of the present invention. The method for enabling the pre-handover procedure comprises identifying a trigger condition for the pre-handover procedure from a device, at step 205. The device is where the media experience is being rendered. The method may continually monitor a user's state for a trigger condition. The trigger condition can be a condition for a potential media transfer. Some of the examples of the trigger conditions are the user's location change, availability of devices on which the media experience can be transferred, a historical user behavior, a user initiated trigger, a user departing from a range of the rendering device, and a user entering the range of another device when the second device is more preferred than the first device for rendering. The devices on which the media experience can be transferred are referred to as potential devices and the terms “potential device” and “device on which the media experience can be transferred” are used interchangeably herein. If the trigger condition is met, one of the potential devices is identified where the media experience can be transferred and the media application is prepared to render the media experience in a dormant mode on the device, step 210. Dormant mode is defined as a state where the media application is prepared but not “rendered” on a device. For example, the Windows Media Player would start streaming but would not display the streamed media. Those skilled in the art will realize that the device rendering the media experience and the device on which the media experience can be transferred are interchangeable. Thus, any one of the two devices can be the user's device on which the media is currently being rendered or a potential device for the transfer of the media experience.

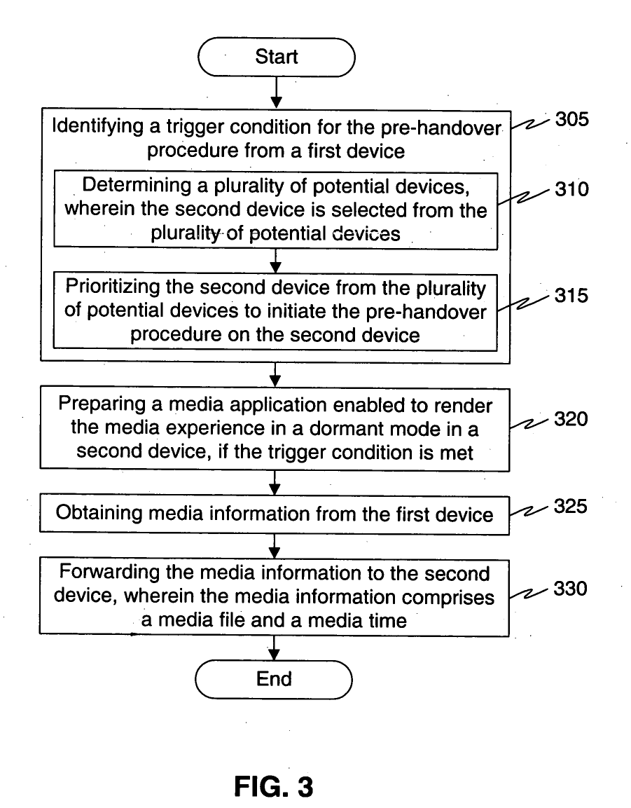

Referring now to FIG. 3, a flow diagram elaborating the method of enabling the pre-handover procedure is shown in accordance with an embodiment of the present invention. A trigger condition is identified for the pre-handover procedure at step 305, and has been described above in FIG. 2 as well. According to an embodiment of the present invention, the identifying step, step 305, may comprise determining a plurality of potential devices where the media experience can be transferred from the device rendering the media experience, step 310. The method can further prioritize a device from the plurality of potential devices, step 315. This enables initiating the pre-handover procedure on the prioritized device, step 320. Those skilled in the art shall realize that more than one device can be prioritized for rendering the media experience. The pre-handover procedure depicted in FIG. 2, further comprises obtaining media information, step 325, from the device rendering the media experience and forwarding the media information, step 330, to the prioritized device. The media information can comprise a media file and a media time. An example of the media file can be a song in MPeg Layer 3 (MP3) format, and the media time can be the duration of the MP3 song already rendered.

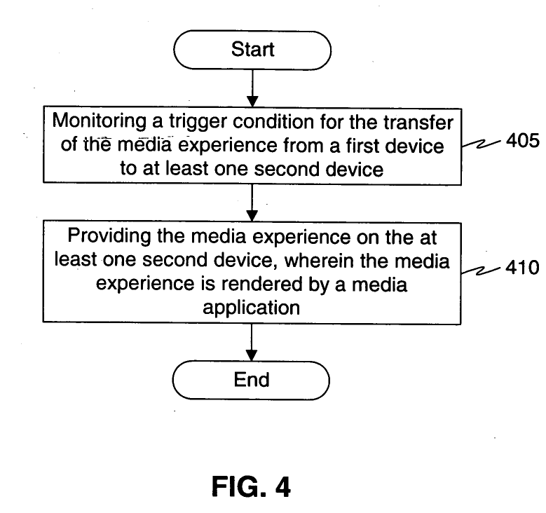

Referring now to FIG. 4, a flow diagram depicting a method to enable a transfer of a media experience across a plurality of devices is shown in accordance with an embodiment of the present invention. The method involves monitoring a trigger condition for the transfer of the media experience from a device rendering the media experience to at least one device on which the media experience can be transferred at step 405, wherein the device on which the media experience can be transferred is a potential device. Those skilled in the art will appreciate that the two devices can be interchangeable. A media application on the potential device can be prepared in a dormant mode by the pre-handover procedure described in FIG. 3. If the user handling the device rendering the media experience decides to transfer the media experience to the potential device, the media experience is provided on the potential device. The media experience can be rendered by a media application, for example a media player.

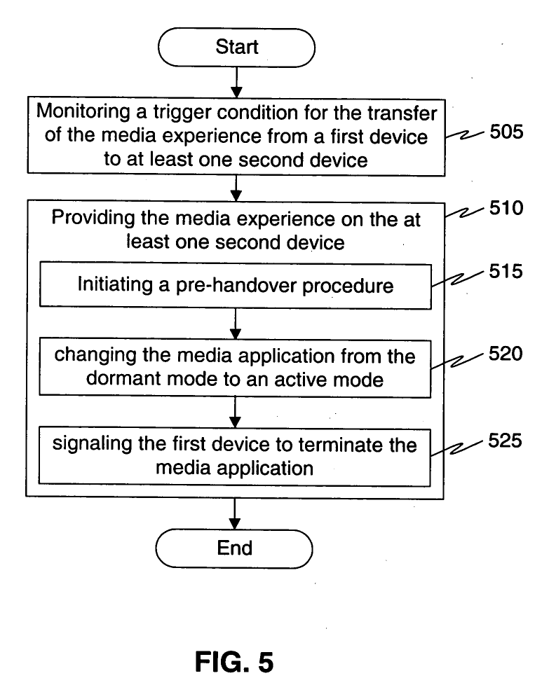

Turning now to FIG. 5, a flow diagram elaborating the step of providing the media experience on a device on which the media experience can be transferred is shown in accordance with an embodiment of the present invention. A trigger condition for the transfer of the media experience from a device rendering the media experience to at least one potential device is monitored at step 505. As such more than one potential device rendering the media experience simultaneously is contemplated and is within the scope of the present invention. Providing the media experience on the at least one potential device, step 510, may comprise initiating the pre-handover procedure at step 515. The pre-handover procedure is described in FIG. 2 and FIG. 3. The providing step 510 further comprises changing the media application from the dormant mode to an active mode, at step 520. The active mode is defined as a state where the media application is prepared and “rendered” on a device. After the media application is changed from dormant mode to active mode, the device rendering the media experience is signaled to terminate the media application at step 525. The user can now experience seamless transfer of media experience from the device rendering the media experience to the potential device.

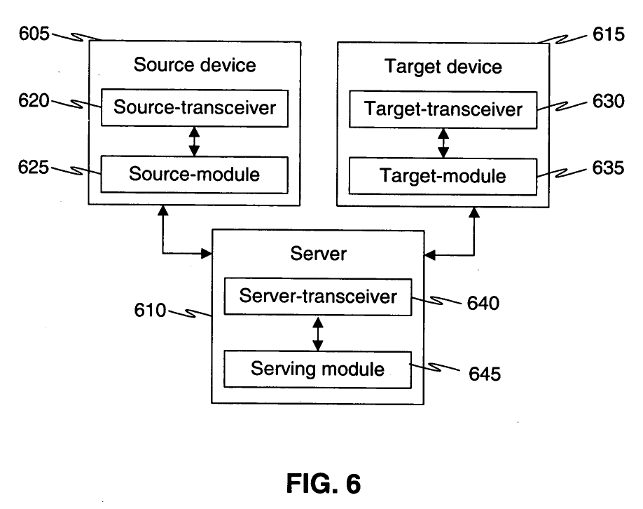

Referring now to FIG. 6, a system to enable a transfer of a media experience across devices is shown in accordance with an embodiment of the present invention. The system comprises a server 610 in communication a first device and an at least one second device. The first device can be a device rendering the media experience, and shall be referred to as source device 605 hereafter. Similarly, the second device can be a device on which the media experience can be transferred, and shall be referred to as target device 615 hereafter. The server 610 comprises a server-transceiver 640 operatively coupled to a serving module 645. The serving module 645 is configured to identify a trigger condition for the pre-handover procedure from the source device 605. The serving module 645 can further prepare a media application enabled to render the media experience in a dormant mode in the target device 615, if the trigger condition is met. The source device 605 comprises a source-transceiver 620 operatively coupled with a source-module 625. The source-module 625 is configured to transmit media information to the server 610. Similarly, the target device 615 comprises a target-transceiver 630 and a target-module 635. The target-module 635 is configured to receive media information from the server 610 and change a media application from a dormant mode to an active mode.

In one embodiment of the present invention the source-module 625 and the target-module 635 can reside on all devices in the defined environments, whereas in another embodiment, the source-module 625 and the target-module 635 have similar functionalities, thus enabling any device to behave as a source device or a target device in a given situation. For example, referring to the embodiment 100 depicted in FIG. 1, a user traveling into a home 110 is shown. In this situation, the user's mobile phone 115 acts as a source device 605, and the music system 120 at home 110 acts as the target device 615. However, if the user walks out of the home 110, wherein the music system 120 is rendering the media experience, the music system 120 will behave as the source device 605 and the user's mobile phone 115 behaves as the target device 615.

Those skilled in the art shall realize that an application module and an application server may be required to coordinate the seamless transfer of media experience across devices. The application modules can reside on the source device 605 and on the target device 615. In one embodiment of the present invention, the application module for the source device can be different from the application module for the target device.

In one embodiment of the present invention the media is stored locally in a network instead of being streamed, for example in a local store comprising a hard disk or a flash memory card. In this case, a target device on which the user wishes to transfer the media experience may retrieve the media from a local store instead of communicating with a server.

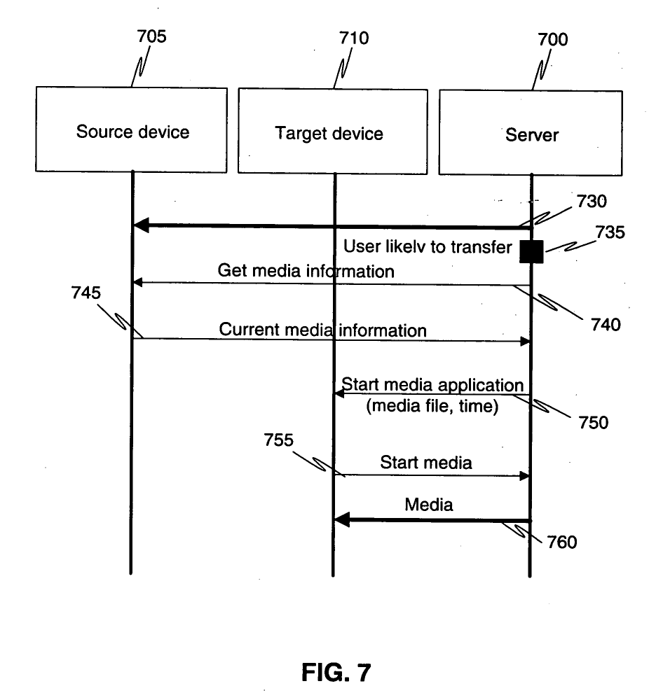

Referring now to FIG. 7, an exemplary embodiment depicting a pre-handover procedure is shown. A server 700 is in communication with a source device 705 and a target device 710. The source device 705 is a device rendering media experience and a target device 710 is a device on which the media experience can be transferred. Pursuant to the embodiment depicted in FIG. 6, the source device 705 can comprise a source-transceiver and a source-module, the target device 710 can comprise a target-transceiver and a target-module and the server 700 can comprise a server-transceiver and a serving module. The source-transceiver and the target-transceiver may enable the source device 705 and the target device 710 to communicate with the server respectively.

The server 700 can detect a potential handover case based on a trigger condition, for example, a change in the defined environment of the devices, a change in the network or a change in the available devices. As mentioned earlier, the defined environments where the devices exist can comprise an office environment, a home environment, and an auto environment, or a user handling a device could be in transit or out-in-the-world environment. The server 700 may continually monitor the state of the user handling the device rendering the media experience for a trigger condition at step 730. The potential devices on which media experience can be rendered are then determined. A device can further be prioritized/selected from the potential devices in order to initiate the pre-handover procedure on it. For example, the device prioritizing can be done by considering the user's historical behavior, for instance the potential devices the user usually prefers transferring the media experience to. Further the device can also be prioritized based on a user's location change, availability of devices on which the media experience can be transferred and a user initiated trigger. In accordance with the embodiment depicted in FIG. 7, the prioritized device is the target device 710. Those skilled in the art shall appreciate that more than one target device can be prioritized for the media experience to start rendering the media experience, however only one target device, target device 710, is shown for ease of representation. Those skilled in the art shall appreciate that if the transfer of the media experience between the source device 705 and the target device 710 is anticipated and is such that the user is completely without access to the streaming content for a period of time, when the target device 710 is not warmed-up, then the target device 710 can be warmed-up earlier or with a higher priority.

For example, a user, who is currently listening to music (in the form of streaming content) within his car on the source device 705, the car music system, leaves his car and wishes to continue listening to the music on the target device 710, his mobile phone. If his mobile phone is not warmed-up to receive the streaming content, the user can potentially be without the streaming content for a period of time. Thus, in this example, warming up his mobile phone is a higher priority or to be done earlier in order to avoid the case where the user leaves his car and the mobile phone is not able to immediately start rendering the music and to ensure continuous rendering of the media experience. In contrast, for example, if the user is currently listening to a song on his mobile phone, and it is anticipated that the user might enter his car, then even if the car is not warmed-up to immediately start the song when the user enters the car, the user can continue to listen to the song through his mobile phone. Thus, in this case, warming up his car to receive the song before he enters the car is a lower priority since the user will be able to continue rendering the song over his mobile phone while the car warms-up to take over playing the song.

Additionally, this method takes into account how long it takes to warm-up a potential device. If it takes multiple minutes to warm-up the potential device, then that potential device needs to be warmed up earlier than in a situation in which the potential device can be warmed-up in five seconds. For example if the time taken for warming up a device is less than the time taken for warming up other potential devices, then the device is given lesser priority for warming up.

Additionally, this method for prioritizing how quickly devices are warmed-up can take into account the Radio Frequency (RF) costs of warming up different devices. For example, users that are at the edge of an RF sector (defined environment) and have poor signal strength generally use five times or more RF resources per second they are on the RF channel. Thus, if a potential device is on the edge of the RF sector or has poor signal strength, then it can receive lower priority for warming up. In contrast, if a potential device is near a tower transmitting the RF or has good signal strength, then it can receive higher priority for warming up.

Additionally, if the potential device has low battery life, then warming it up can lead to excessive resource utilization and it can potentially drain the last bit of battery life. Thus if the potential device has more remaining battery life, that potential device has lower priority relative to being warmed-up.

Those skilled in the art will appreciate that while warming up a potential device, one may not actually warm it up with the full quality streaming content. Instead, one may only warm-up the potential device with lower quality version of the streaming content. For example, if the user is listening to a song in his car, then only his phone may be warmed up with a low quality (for example FM quality), low bit rate streaming audio version of that song (for example instead of a CD-quality version of the song). In this way, the system costs of warming up the potential device can be limited while making sure that the user does not have an absolute gap where the user cannot listen to the streaming content with at least some minimum quality for some period of time while the potential device is being warmed-up.

Referring back to FIG. 7, after prioritizing the target device 710 from the potential devices for rendering the media experience, the pre-handover procedure is initiated at step 735. The server 700 sends a request to the source device 705 to obtain the media information at step 740. The media information can comprise the media file and the media time. A media application rendering the media experience on the source-device 705 may be responsible for sending the media information to the source-module of the source device 705. The source device 705 forwards this media information to the server 700 at step 745. The server 700 communicates with the target device 710 to start the media application in a dormant mode at step 750. The dormant mode is defined as a state where the media application is prepared but not “rendered” on a device. The target device 710 requests the server 700 for the media information at step 755. Upon receiving the request the server 700 forwards the media information to the target device 710 at step 760.

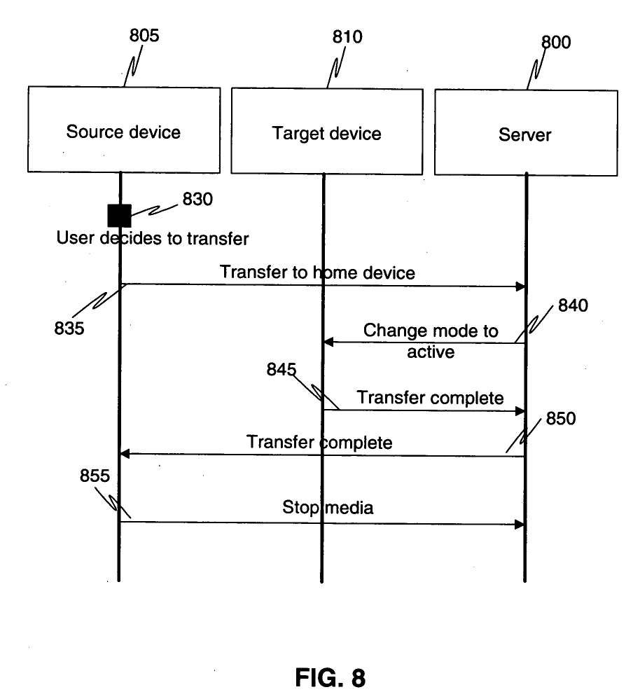

Referring now to FIG. 8, an exemplary embodiment depicting a handover procedure is shown. As depicted in FIG. 7, the pre-handover procedure causes the media application on the target device to be started in the dormant mode. Turning now to FIG. 8, the handover procedure is initiated once the user of a source device 805 decides to transfer the media experience, at step 830, to a target device 810. The source device 805 sends a request to a server 800 to transfer the media experience to the target device 810 at step 835. In response to this request, the server 800 communicates with the target device 810 to change the media application mode from dormant mode to active mode at step 840. A target-module on the target device 810 instructs the media application on the target device 810 to start rendering the media. Upon the media information being transferred completely to the target device 810, the target device 810 informs the server 800 about the transfer of media at step 845. The server 800, in turn, informs the source device 805 about the transfer of media at step 850. The source device 805 instructs the server 800 to stop rendering the media on the source device 805 at step 855. Thus, pursuant to various embodiments of the present invention, a seamless transfer of media experience across devices can occur, thereby enhancing user experience.

The present invention reduces the handover delay and provides more seamless transfers of media experiences across devices. It further enables reducing the warm up time involved in the inter device transfer (e.g. transfer from a cellular data network to a WiFi network) of media experience. The invention proposes a pre-handover procedure, which can be initiated by a user trigger or can be initiated automatically. The present invention is also capable of anticipating likelihood of transfer of media experience.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of enabling a pre-handover procedure of a media experience across a plurality of devices, the method comprising steps of:
identifying a trigger condition for the pre-handover procedure from a first device; and,
preparing a media application enabled to render the media experience in a dormant mode in a second device, if the trigger condition is met.

2. The method of claim 1, wherein the identifying step further comprises monitoring for the trigger condition.

3. The method of claim 1, wherein the identifying step comprises:
determining a plurality of potential devices, wherein the second device is selected from the plurality of potential devices.

4. The method of claim 3 wherein the identifying step further comprises:
prioritizing the second device from the plurality of potential devices to initiate the pre-handover procedure on the second device.

5. The method of claim 4 wherein prioritizing the second device comprises warming up the second device in advance to ensure continuous rendering of the media experience.

6. The method of claim 4 wherein prioritizing the second device comprises prioritizing the second device when the time taken for warming up the second device is less than the time taken for warming up other potential devices.

7. The method of claim 4 wherein prioritizing the second device comprises prioritizing the second device based on at least one factor from the group consisting of: Radio Frequency (RF) costs associated with warming up the second device, a battery life of the second device, and a quality of the media experience.

8. The method of claim 1, wherein the trigger condition comprises at least one condition from the group consisting of a location change, an availability of a third device, a historical user behavior, a user initiated trigger, a user departing from a range of the first device, and a user entering the range of the second device when the second device is more preferred than the first device for rendering.

9. The method of claim 8, wherein the preparing step comprises prioritizing the preparation of the media application for the second device more highly when the trigger condition is the user departing from the range of the first device than when the trigger condition is the user entering the range of the second device.

10. The method of claim 1 further comprising:
obtaining media information from the first device; and
forwarding the media information to the second device, wherein the media information comprises a media file and a media time.

11. The method of claim 1, wherein the media application obtains media content of a streaming application from a distinctly located streaming server.

12. The method of claim 1, wherein the media application obtains media content from local storage, the local storage comprising at least one of a hard disk and a flash memory card.

13. The method of claim 1, wherein the preparing step further comprises providing to the second device information from the group consisting of presence information, bookmark information and address book information.

14. A method to enable a transfer of a media experience across a plurality of devices, the method comprising steps of:
monitoring a trigger condition for the transfer of the media experience from a first device to at least one second device; and
providing the media experience on the at least one second device, wherein the media experience is rendered by a media application.

15. The method of claim 14, wherein the providing step comprises:
changing the media application from the dormant mode to an active mode; and
signaling the first device to terminate the media application.

16. The method of claim 14, wherein the providing step comprises:
initiating a pre-handover procedure.

17. The method of claim 16, wherein the initiating step comprises:
obtaining media information from the first device;
forwarding the media information to the at least one second device; and
starting the media application in a dormant mode on the at least one second device on receiving the media information.

18. A system to enable a transfer of a media experience, the system comprising:
a first device;
a second device; and
a server in communication with the first device and the second device, the server comprising:
a server-transceiver; and
a serving module, the server-transceiver operatively coupled to the serving module, wherein the serving module is configured to:
identify a trigger condition for the pre-handover procedure from the first device; and
prepare a media application enabled to render the media experience in a dormant mode in the second device, if the trigger condition is met.

19. The system of claim 18, wherein the first device comprises:
a first transceiver; and
a first module, operatively coupled to the first transceiver, wherein the first module is configured to transmit media information to the server.

20. The system of claim 18, wherein the second device comprises:
a second transceiver; and
a second module, operatively coupled to the second transceiver, wherein the second module is configured to:
receive media information from the server; and
change a media application from a dormant mode to an active mode.
